(19) United States
(12) Patent Application Publication
(10) Pub. No.: US 2023/0280990 A1
(43) Pub. Date: Sep. 7, 2023

(54) SYSTEM AND METHOD FOR SOURCE CODE TRANSLATION USING AN INTERMEDIATE LANGUAGE

(71) Applicant: Next Pathway Inc., Toronto (CA)

(72) Inventor: Vladimir Antonevich, Toronto (CA)

(21) Appl. No.: 18/174,815

(22) Filed: Feb. 27, 2023

Related U.S. Application Data
(60) Provisional application No. 63/316,447, filed on Mar. 4, 2022.

(51) Int. Cl. G06F 8/41

(52) U.S. Cl. CPC G06F 8/443; G06F 8/427

(57) ABSTRACT

A system and method for migrating data management code converts input source code compatible with a source platform to output source code compatible with a target platform. The source code is parsed to generate an intermediate representation of the input source code based on an abstraction model. The abstraction model is structured to include one or more workflows, with each workflow including data manipulation units and/or execution plans for controlling the execution of activities contained therein. The intermediate representation is formatted into the output source code. The output source code may be packaged for deployment on the selected one of the one or more target platforms.

### CROSS REFERENCE TO RELATED APPLICATION

This application claims priority from and incorporates by reference U.S. Provisional Patent Application Ser. No. 63/316,447, filed on Mar. 4, 2022.

### TECHNICAL FIELD

The present disclosure relates generally to automated source code generation, and more specifically to a method and system to automatically translate source code compatible with a source platform to source code compatible with a target platform. Particular embodiments have example applications for translating Extract-Transform-Load (ETL) code and/or database code.

### BACKGROUND

Big Data is a term for data sets that are so large or complex that traditional data processing applications are inadequate to deal with data sets of this size. Data sets grow rapidly in part because of the increased use of sensing devices and networks, which operate as cheap and numerous sources of information. As a result, the world's technological per-capita capacity to generate and store information has increased phenomenally.

Advancements in cloud-based technologies have enabled the establishment of highly versatile and scalable computing systems. Such systems are appealing to business users who desire to maintain and operate their corporate and enterprise data systems within distributed computing environments. As such, it is desirable to migrate existing data sets residing within legacy data systems to a cloud-based enterprise data lake or a cloud-based data platform to take advantage of the versatility and scalability of distributed computing systems.

The task of moving data to a cloud-based enterprise data lake or cloud-based data platform involves both moving the data as well as the various customized applications and processes that have been developed to manage and analyze the data. One example area of focus is the movement of data from legacy data warehousing solutions, database systems and Extract Transform and Load (ETL) platforms to more modern data warehousing solutions and ETL platforms (e.g., cloud-native enterprise solutions as offered by cloud vendors). These modern platforms can offer scalability, a more open and flexible architecture, and a lower cost of data ownership. However, the task of migrating from legacy vendor solutions to modern, cloud-native solutions can be challenging.

One method of migrating data from legacy solutions to modern solutions is to perform a “lift-and-shift” migration, where an exact copy of a source application is replicated and re-hosted on the target cloud platform. This method can be cost-effective, but does not optimize the migrated application to take full advantage of the new cloud environment. Another method is to rewrite the entire data pipeline of a source into the target vendor system codebase. This method typically requires manual translation of the corresponding source code written in a programming language for execution by a legacy system into source code written in a different programming language that can be executed by the target system.

Manual translation of source code can be a complex task that requires collaboration between many skilled developers who are knowledgeable about both the source and target vendor systems. The complexity is exacerbated when migrating from legacy Enterprise Data Warehouse (EDW) infrastructure to modern cloud-based infrastructure(s). For example, multiple source ETL formats could exist in the legacy system and it may be desirable to translate ETL code from each of the existing formats to one or more target ETL formats compatible with the modern system. In addition, tasks such as manually rewriting Structured Query Language (SQL) queries, analytical and reporting workloads, and stored procedures can be particularly complicated, time-consuming, resource intensive, and error-prone. Translation of source code by a team of developers may further introduce inconsistencies in respect of the potentially different coding styles and coding logic applied by each individual developer to translate the source code.

Accordingly, in view of the foregoing deficiencies, there is a general need for systems and methods that translate source code compatible with a source platform to source code compatible with a target platform in a manner that addresses the above-noted disadvantages of existing code translation approaches. There is a particular need for systems and methods that facilitate efficient, cost-effective and accurate translation of source code, such as ETL code, existing in one or more source languages or formats to source code in any one of multiple desired target source languages or formats.

### SUMMARY OF THE DISCLOSURE

In general, the present specification describes a system and method to automatically translate source code from a source language to a target language. Embodiments described herein may have example applications for migrating data management codebase, such as ETL or ELT codebase, from a legacy platform to a modern platform (e.g., cloud platform).

One aspect provides a computer implemented method for migrating data management code from one or more source platforms to one or more target platforms. The method involves the steps of receiving input source code compatible with at least one of the one or more source platforms, parsing the input source code to generate an intermediate representation of the input source code based on an abstraction model, formatting the intermediate representation into output source code compatible with selected target platform(s), and packaging the output source code for deployment on the selected target platform(s). The abstraction model is structured to include one or more workflows. Each of the one or more workflows includes data manipulation units and/or execution plans for controlling the execution of activities contained therein. The input source code may be ETL source code and the abstraction model may be an ETL abstraction model.

In some embodiments, the input source code is parsed by combining a retained segment of the input source code with code corresponding to constructs extracted from a non-retained segment of the input source code based on the abstraction model. The retained segment of the input source code may include expression code for direct execution on the selected target platform(s).

In some embodiments, the intermediate representation is optimized based on one or more sets of optimization rules first before the optimized intermediate representation is formatted into output source code compatible with the selected target platform(s). The optimization rules may be based on an evaluation of trade-offs between performance and execution cost of the output source code.

In some embodiments, the intermediate representation is iteratively formatted into output source code compatible with additional target platform(s) and the additional output source codes are packaged for deployment on the additional target platform(s). In some embodiments, the abstraction model is formalized in YAML file format and the intermediate representation is stored in one or more YAML files.

A further aspect provides a system for migrating data management code from one or more source platforms to one or more target platforms. The system is designed or otherwise configured to migrate data management code using computer-implemented methods described herein. In particular embodiments, the system includes an input parser for parsing input source code compatible with at least one of the source platforms to generate an intermediate representation of the input source code based on abstraction models described herein, an output formatter for formatting the intermediate representation into output source code compatible with selected target platform(s), and a deployment module for packaging the output source code for deployment on the selected target platform(s).

Additional aspects of the present invention will be apparent in view of the description which follows.

### BRIEF DESCRIPTION OF THE DRAWINGS

Features and intended advantages of the embodiments of the present invention will become apparent from the following detailed description, taken with reference to the appended drawings in which:

FIG. 1 is a block diagram depicting an example embodiment of an architecture that can be used to convert source code compatible with a source platform to source code compatible with a target platform.

FIG. 2 is a block diagram of an example embodiment of a code generator that may be used in the FIG. 1 architecture.

FIG. 2A depicts an exemplary application of using the FIG. 2 code generator to migrate an ETL codebase from a legacy ETL platform to a modern ETL platform.

FIG. 3 depicts an ETL abstraction model according to an example embodiment of the invention.

FIG. 4 depicts an exemplary method of optimizing an intermediate representation of input source code before formatting the optimized intermediate representation into output source code.

### DETAILED DESCRIPTION

The description which follows, and the embodiments described therein, are provided by way of illustration of examples of particular embodiments of the principles of the present invention. These examples are provided for the purposes of explanation, and not limitation, of those principles and operation of the invention.

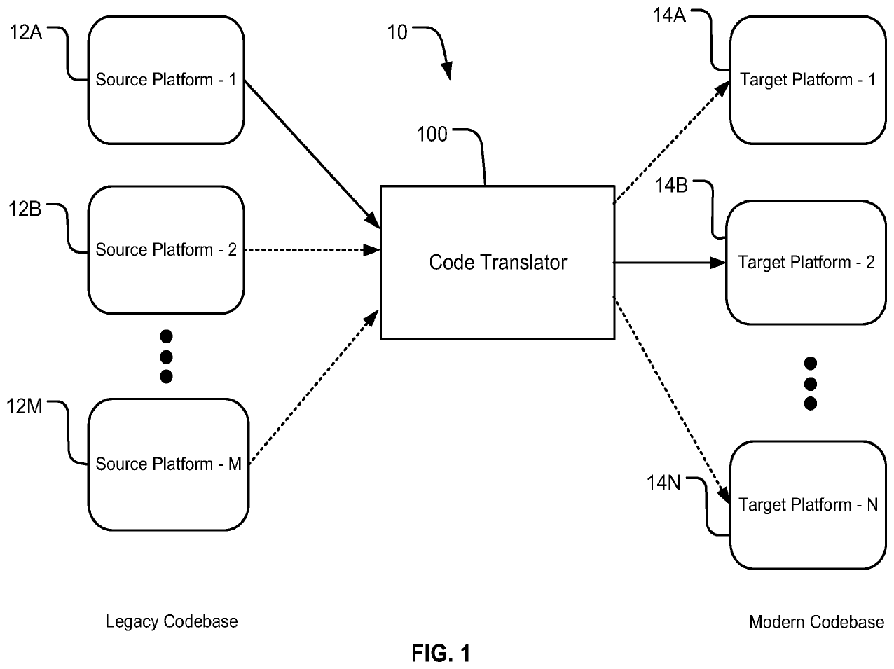

FIG. 1 is a block diagram depicting an architecture 10 that can be used to convert source code compatible with a source platform 12 to source code compatible with a target platform 14. Architecture 10 can be used, for example, by enterprises to automatically migrate their data management codebase (e.g., ETL codebase, ELT codebase, etc.) from a source vendor ETL platform to a target vendor ETL platform with minimum human supervision and intervention.

Architecture 10 includes a code translator 100 for translating source code in one or more source platforms 12 to an intermediate representation of the source code. The intermediate representation is then persisted using a human-readable file format described in more detail below as an intermediate language (IL). The intermediate representation is then formatted to source code in one or more target platforms 14. As described in more detail below, code translator 100 determines an abstraction of common programming constructs (e.g., ETL constructs) and uses the abstraction to support code migration projects for multiple source-to-target combinations. That is, code translator 100 may use the abstraction and intermediate representation to convert source code compatible with any one of source platforms 12A, 12B, . . . 12M to source code compatible with any one of target platforms 14A, 14B, . . . 14N.

By first translating source code in a source platform 12 to an intermediate representation in the IL, code translator 100 can support multiple source-to-target translations without having the need to directly support each combination of source-to-target translations. That is, code translator 100 does not need to include any specific end-to-end source-to-target translation rules for directly converting source code in a specific source platform 12A to source code in a specific target platform 14A. Illustratively, architecture 10 reduces the number of translation combinations that need to be supported by code generator 100. For example, if there are codebases in M source platforms that need to be migrated to N target platforms, then code generator 100 would only need to support (M+N) translation combinations by using architecture 10 (as opposed to (M*N) combinations by using traditional migration techniques).

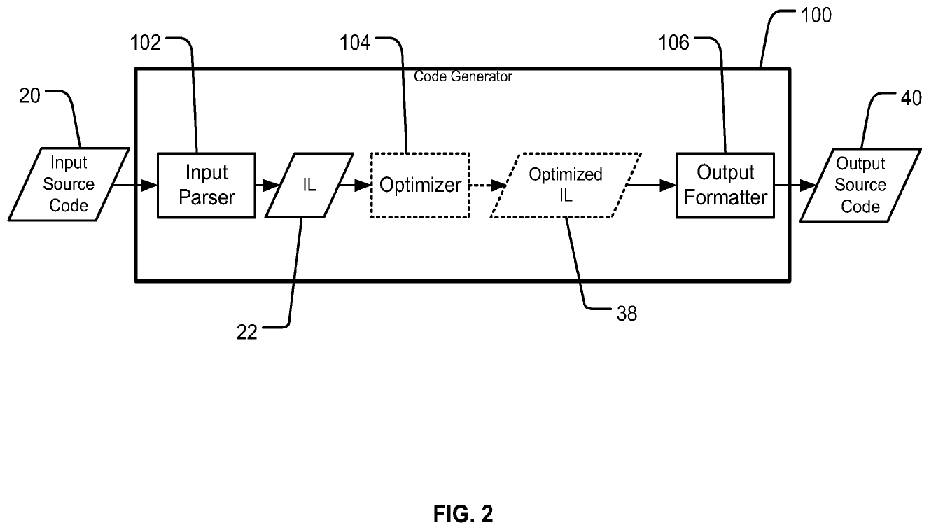

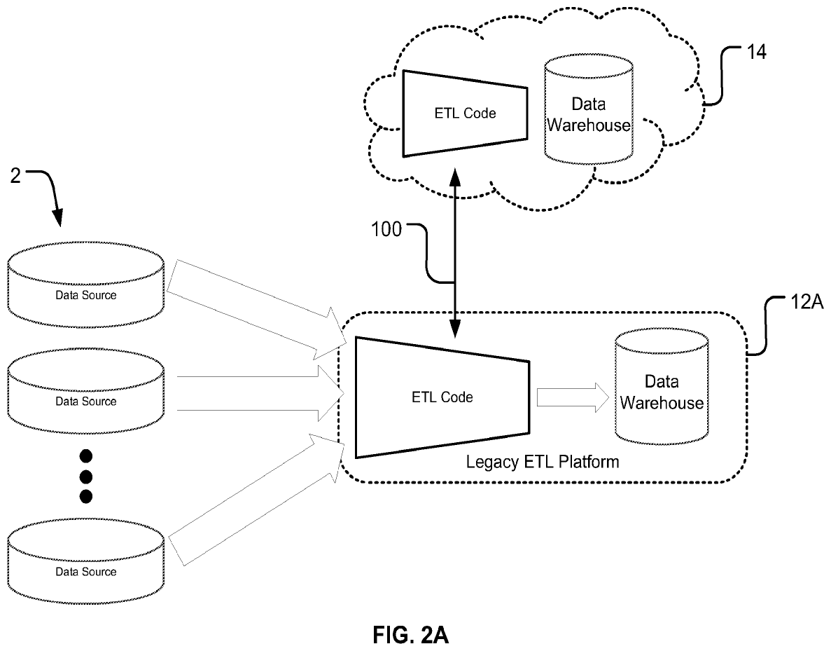

Referring now to FIG. 2, shown therein is a block diagram of an example embodiment of a code generator 100 that may be used in architecture 10. Code generator 100 may be used to migrate data workflows, pipelines, and various codebases from a source platform 12 to a target platform 14. In one embodiment, code generator 100 is configured or otherwise designed to migrate database codebase (i.e., code that runs on a database server and is often written in a vendor-native variant of the SQL programming language, code that implements stored procedures, user-defined functions, and other scripting tools, etc.) from a source database system to a target database system. In another embodiment, code generator 100 is configured or otherwise designed to migrate ETL codebase (i.e., code that is executed by an ETL server as part of a data pipeline, code specific to an ETL product from a vendor, etc.), or the like, from a source ETL platform to a target ETL platform. Since migration projects may involve the conversion of either or both database codebase and ETL codebase, or the like, from a source platform 12 to a target platform 14, one or various variants of code generator 100 can be used in migration projects to reduce the amount of human intervention or supervision required.

FIG. 2A depicts an exemplary application of using one embodiment of code generator 100 to migrate an ETL codebase from a legacy ETL platform 12A to a modern ETL platform 14A (e.g., a cloud-based ETL platform, a cloud-based ELT platform, etc.). As depicted in FIG. 2A, legacy ETL platform 12A includes ETL codebase (written in a language or format compatible with ETL platform 12A) for extracting data from data sources 2, transforming the extracted data, and storing the transformed data in a data warehouse of ETL platform 12A. In circumstances where it is desirable to use a new ETL platform 14A (e.g., a modern ETL platform, an ELT platform, or the like), code generator 100 can be used to migrate existing ETL code in legacy ETL platform 12A to new ETL platform 14A.

Illustratively, aspects of the invention described herein may be particularly applicable for migrating ETL codebase since enterprises tend to be particularly reluctant to rewrite their entire ETL codebase (e.g., a codebase in a legacy platform) on multiple target platforms (e.g., cloud platforms). This is often due to the significant time required to complete ETL migration projects, the uncertainty around the successful completion of such projects, and the complex procedures involved with data validation and testing of the converted ETL code. In addition, existing ETL code may sometimes be written in old programing languages, thereby requiring programmers with the right skillset to undertake an ETL migration project.

As depicted in FIG. 2, translation of input source code 20 in a source language (e.g., ETL code in a source platform 12) to corresponding output source code 40 in a target language (e.g., corresponding ETL code in a target platform 14) involves a multi-step process. In a first step of the multi-step process, input source code 20 is translated by an input parser 102 of code generator 100 to an intermediate representation 22 of input source code 20. Intermediate representation 22 is coded in an intermediate language formalized in a suitable file format, such as YAML, as described in more detail below. Input parser 102 may be implemented using systems and methods that are capable of interpreting the grammatical structure of input source code 20 and/or utilize a parse tree (e.g., in a bottom-first, left-first order) with stream expressions and mutation rules to automatically convert input source code 20 to intermediate representation 22. In one example embodiment, input parser 102 may be based on systems described in U.S. Patent Publication No. 2020/0285454 to Antonevich et al., which is incorporated herein by reference. In such example embodiments, input parser 102 may be configured with one or more expression values and/or one or more parameter options that provide descriptive information of the intermediate language.

Input parser 102 may abstract out primary constructs from certain segments of input source code 20 while retaining other segments of input source code 20. For example, input parser 102 may retain segments of expression code that need to be directly executed on target platform 14 (i.e., where it would be difficult to convert expression code into an abstraction without knowing beforehand which target platform 14 the expression code would be run on). As another example, input parser 102 may extract from input source code 20 segments associated with data sources 2 and data targets (e.g., data warehouses), transformations that are performed (including any orchestration information), source SQL code, and expressions that execute on the data sources 2. The extracted information may then be mapped to their intermediate language constructs. The intermediate language constructs corresponding to the extracted information may be combined with the retained segments of input source code 20 to generate intermediate representation 22.

As described elsewhere herein, intermediate representation 22 may be based on one or more abstraction models of data processing jobs (e.g., ETL processing jobs). The abstraction model may be formalized using a data-serialization language such as YAML or any markup language such as XML or JSON. The abstraction model may also be referred to herein as an intermediate language (IL).

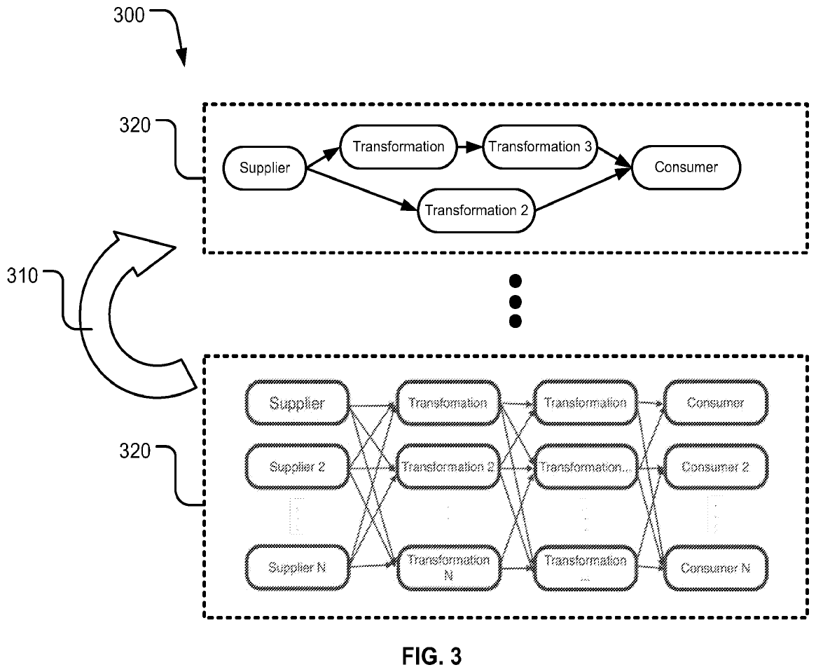

FIG. 3 schematically illustrates an abstraction model 300 according to an example embodiment. Abstraction model 300 defines flow of data between processing steps, such as from data sources 2 through data transformation to a data consumer (e.g., data warehouses in FIG. 2A). In abstraction model 300, step-by-step data transformation may be defined as a Direct Acyclic Graph where no dependency cycle can exist (i.e., a parent node can have one or many children and a child node can have one or many parents, but a child can never be an ascendant of its parent).

Abstraction model 300 may be formalized to include the commonalities of constructs as they exist across multiple vendor codebases (e.g. multiple different target ETL platforms 14). In some embodiments, the formalization involves initializing an intermediate language YAML file. Once such an intermediate language YAML file is initialized, input parser 102 can populate the YAML file with code to generate intermediate representation 22 of input source code 20. Illustratively, the YAML file format can provide grammar definitions and facilitate the use of convenient syntax for providing structure (e.g., indentations rather than braces to indicate the start and end of segment blocks).

Abstraction model 300 may be structured like a tree to include one or more workflows. In some embodiments of abstraction model 300, a workflow can include one or more execution plans 310 for orchestrating or otherwise controlling the execution of activities contained therein. Examples of activities that may be contained within an execution plan 310 include, but are not limited to: running one or more data manipulation units 320, running shell commands or shell script files, running a routine job, starting a loop, ending a loop, defining global variables, branching the execution, and specifying information about notification activity.

Data manipulation units 320 can share common job attributes with one another. Data manipulation units 320 typically include a collection of steps (executed during the ETL process execution) pertaining to the movement of the data from source (e.g., data source 2) to target (e.g., the data warehouse of an ETL platform), and/or the transformation of data from one state to another. Examples of steps that may be performed in a data manipulation unit 320 include, but are not limited to: reading data from a file, writing data to a file, reading data from a table, view or query, writing data to a database table, filtering data by skipping non-conformant tuples, mapping relations between data, joining mapped relations, and grouping relations as per a certain grouping criteria.

Data manipulation units 320 in abstraction model 300 may correspond to segments or portions of input source code 20 that are responsible for obtaining data from multiple source types (e.g., flat file, XML files, database tables, or heterogeneous combinations of these), transforming the obtained data into various forms, and/or writing the transformed data to different target types (e.g., flat files, XML files, database tables, or heterogeneous combinations of these).

Linkages between the various elements in abstraction model 300 may be established through connecting points. Examples of connecting points include “triggers” for execution plan activities and “sources” for the steps contained within a data manipulation unit. Such linkages allow for the creation of a complete DAG structure that can be easily formatted by output formatter 106 to output source code 40.

As described above, abstraction model 300 may be formalized as a YAML file, or the like, containing a root element (e.g., “model”) and split into multiple sections. As an example, the YAML file may include a “configuration” section containing parameters required to describe the ETL unit. As another example, the YAML file may include a “parameters” section defining the names of runtime configuration parameters that will be expanded at execution. As another example, the YAML file may include a “constant” section mapping names of the constants used in model definition to their values specified as expressions (i.e., a combination of YAML literals with references to other constants or parameters). As another example, the YAML file may include a “workflow” section containing a collection of workflows described above.

One example of an intermediate representation 22 based on abstraction model 300 formalized as a YAML file is provided below:
model:
   config:
      origin: etl_plaform_source
   jobs:
      name: workflow1
      origin: etl_plaform_source
      type: execution_plan
      activities:
         name: w1_activity1
         type: sequencer
         triggers:
         activity: w1_activity2
         name: w1_activity2
         type: data_manipulation_unit1
         steps:
         name: w1_a2_step1
         type: fileReader
         name: w1_a2_step2
         type: map
         source: w1_a2_step1
      name: workflow2
      origin: etl_plaform_source
      type: execution_plan
      activities:
         name: w2_activity1
         type: sequencer
         triggers:
         activity: w2_activity2
         name: w2_activity2
         type: data manipulation_unit2
         steps:
         name: w2_4_step1
         type: fileReader
         name: w2_a2_step2
         type: map
         source: w2_a2_step1
         triggers:
         activity: w2_activity3
         name: w2_activity3
         type: terminator

In the provided example, intermediate representation 22 comprises two workflows (i.e., “workflow1”, “workflow2”). The first workflow includes two execution plan activities (i.e., “w1_activity1”, “w1_activity2”), with the second execution plan activity containing a data manipulation unit (i.e., “data_manipulation_unit1”) and the data manipulation unit containing two steps (i.e., “w1_a2_step1”, “w1_a2_step2”). The second workflow includes three execution plan activities (i.e., “w2_activity1”, “w2_activity2”, “w2_activity3”), with the second execution plan activity containing a data manipulation unit (i.e., “data_manipulation_job2”) and the data manipulation unit containing two steps (i.e., “w2_a2_step1”, “w2_a2_step2”).

Illustratively, the structure of abstraction model 300 allows commonalities that exist across multiple vendor platforms to be identified. Abstraction model 300 also allows comparable constructs across various platforms (e.g., various ETL platforms) to be introduced and incorporated therein. For example, since some ETL platforms may have unique capabilities that are not present across all ETL platforms, abstraction model 300 may include a superset of ETL constructs present across multiple ETL platforms. By representing input source code 20 as a collection of workflows, execution plans of workflows, data manipulation units within execution plans, and steps of data manipulation units, code generator 100 can generate output source code 40 compatible with any selected one of multiple target platforms 14 by formatting the intermediate representation 22 according to a language or form that is compatible with the selected platform 14.

In addition, the structure of abstraction model 300 allows intermediate representation 22 to be optimized by optimizer 104 into an optimized intermediate representation 38 before it is formatted by output formatter 106 to a desired output source code 40 (i.e., source code in the form or language that is compatible with target platform 14).

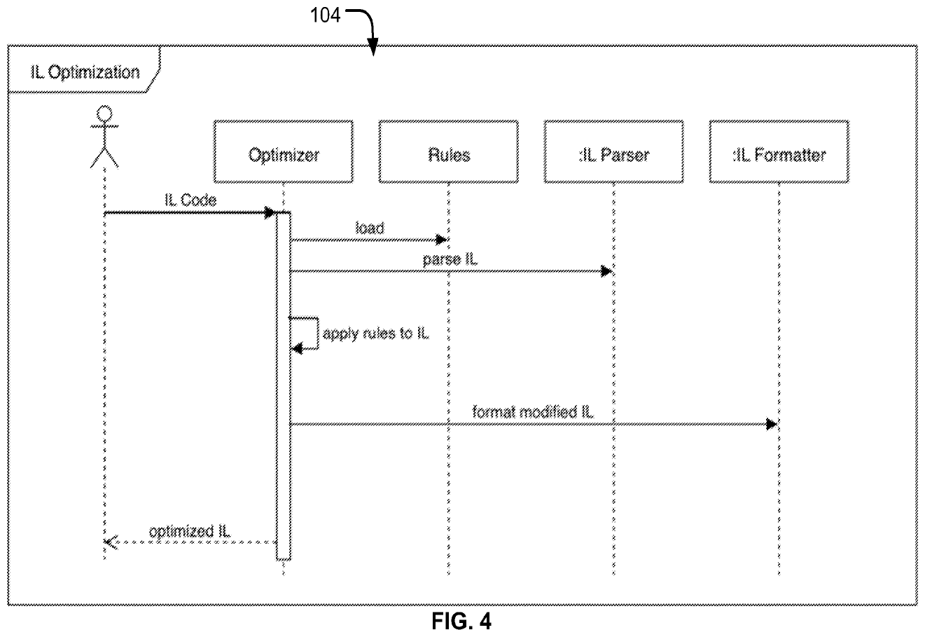

FIG. 4 depicts an exemplary method of optimizing intermediate representation 22 for formatting to output source code 40. The method may be implemented by optimizer 104 of code generator 100. Optimizer 104 may optimize intermediate representation 22 by parsing and reformatting intermediate representation 22 based on one or more sets of optimization rules to generate optimized intermediate representation 38. For example, optimizer 104 may optimize intermediate representation 22 by transforming parts of ETL transformation code to native SQL code that can be executed directly on databases of target platforms 14. As another example, optimizer 104 may optimize intermediate representation 22 by simplifying execution plans 310. In one example embodiment, optimizer 104 is configured to evaluate trade-offs between performance and execution cost. In such example embodiments, the optimization rules may be based on the evaluation and may vary for different target platforms 14.

Referring back to FIG. 2, intermediate representation 22 or optimized intermediate representation 38 is formatted by output formatter 106 of code generator 100 to produce output source code 40 in the final step of the code translation process. In the final step, each of the constructs in the intermediate language are individually mapped to those in the language or format compatible with the target system 14. Optionally, output formatter 106 may generate output source code 40 by formatting intermediate representation 22 or optimized intermediate representation 38 based on the expression parameter values provided to input parser 102.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole.

1. A computer-implemented method for migrating data management code from one or more source platforms to one or more target platforms, the method comprising:
receiving input source code compatible with at least one of the one or more source platforms;
parsing the input source code to generate an intermediate representation of the input source code based on an abstraction model, the abstraction model structured to include one or more workflows, each of the one or more workflows including at least one of: (1) data manipulation units; and (2) execution plans for controlling the execution of activities contained therein;
formatting the intermediate representation into output source code compatible with a selected one of the one or more target platforms; and
packaging the output source code for deployment on the selected one of the one or more target platforms.

2. The method of claim 1, wherein parsing the input source code comprises combining a retained segment of the input source code with code corresponding to constructs extracted from a non-retained segment of the input source code based on the abstraction model.

3. The method of claim 2, wherein the retained segment of the input source code includes expression code for direct execution on the selected one of the one or more target platforms.

4. The method of claim 1, comprising optimizing the intermediate representation based on one or more sets of optimization rules before formatting the optimized intermediate representation into output source code compatible with the selected one of the one or more target platforms.

5. The method of claim 4, wherein the optimization rules are based on an evaluation of trade-offs between performance and execution cost of the output source code.

6. The method of claim 1, wherein the abstraction model is formalized in YAML file format and wherein the intermediate representation is stored in one or more YAML files.

7. The method of claim 1, comprising iteratively formatting the intermediate representation into output source code compatible with additional ones of the one or more target platforms and packaging the additional output source codes for deployment on the additional ones of the one or more target platforms.

8. The method of claim 1, wherein the input source code is ETL source code and wherein the abstraction model is an ETL abstraction model.

9. A system for migrating data management code from one or more source platforms to one or more target platforms, the system comprising:
an input parser for parsing input source code compatible with at least one of the one or more source platforms to generate an intermediate representation of the input source code based on an abstraction model, the abstraction model structured to include one or more workflows, each of the one or more workflows including at least one of: (1) data manipulation units; and (2) execution plans for controlling the execution of activities contained therein;
an output formatter for formatting the intermediate representation into output source code compatible with a selected one of the one or more target platforms; and
a deployment module for packaging the output source code for deployment on the selected one of the one or more target platforms.

10. The system of claim 9, wherein the input parser is configured to parse the input source code by combining a retained segment of the input source code with code corresponding to constructs extracted from a non-retained segment of the input source code based on the abstraction model.

11. The system of claim 10, wherein the retained segment of the input source code includes expression code for direct execution on the selected one of the one or more target platforms.

12. The method of claim 11, comprising an optimizer for optimizing the intermediate representation based on one or more sets of optimization rules to generate an optimized intermediate representation.

13. The method of claim 12, wherein the optimization rules are based on an evaluation of trade-offs between performance and execution cost of the output source code.

14. The system of claim 9, wherein the abstraction model is formalized in YAML file format and wherein the intermediate representation is stored in one or more YAML files.

15. The method of claim 9, wherein the output formatter is configured to iteratively format the intermediate representation into output source code compatible with additional ones of the one or more target platforms and wherein the deployment module is configured to package the additional output source codes for deployment on the additional ones of the one or more target platforms.

16. The method of claim 9, wherein the input source code is ETL source code and wherein the abstraction model is an ETL abstraction model.

17. System having any new and inventive feature, combination of features, or sub-combination of features as described herein.

18. Methods having any new and inventive steps, acts, combination of steps and/or acts or sub-combination of steps and/or acts as described herein.
